(19) United States
(12) Patent Application Publication
(10) Pub. No.: US 2008/0297681 A1
(43) Pub. Date: Dec. 4, 2008

(54) TOP RECEIVING CONTAINER, LIQUID CRYSTAL DISPLAY APPARATUS INCLUDING THE SAME, AND ASSEMBLY METHOD THEREOF

(76) Inventors: Yong-Seok YANG, Asan-si (KR); Jung-Tae Kang, Suwon-si (KR); Jin-Ho Ha, Suwon-si (KR)

Correspondence Address: F. CHAU & ASSOCIATES, LLC, 130 WOODBURY ROAD, WOODBURY, NY, 11797, US

(21) Appl. No.: 12/114,936

(22) Filed: May 5, 2008

(30) Foreign Application Priority Data
Jun. 1, 2007 (KR) 10-2007-0053688

(51) Int. Cl. G02F 1/1333; H01J 9/00

(52) U.S. Cl. 349/58; 445/24

(57) ABSTRACT

A receiving container includes a first frame contacting a first side of a liquid crystal panel, and a second frame contacting a second side of the liquid crystal panel, wherein the first frame and the second frame are combined to fix the liquid crystal panel and comprise different materials.

### CROSS-REFERENCE TO RELATED APPLICATION

This application claims priority to Korean Patent Application No. 10-2007-0053688, filed on Jun. 1, 2007, the disclosure of which is incorporated by reference herein in its entirety.

### BACKGROUND OF THE INVENTION

1. Technical Field

The present disclosure relates to a top receiving container, a liquid crystal display (“LCD”) apparatus including the top receiving container and an assembly method thereof, and more particularly to an LCD apparatus including the top receiving container including at least two different materials and an assembly method thereof.

2. Discussion of the Related Art

In general, an LCD apparatus includes a liquid crystal panel for displaying an image, a panel driving part driving the liquid crystal panel, a backlight unit providing light to the liquid crystal panel, and a receiving container unit. The receiving container unit receives the liquid crystal panel, the panel driving part and the backlight unit.

The liquid crystal panel includes a thin film transistor (“TFT”) substrate having a TFT array, a color filter substrate having a color filter array, and a liquid crystal layer formed between the two substrates. The liquid crystal panel is driven by voltage difference applied between the two substrates to adjust a transmission ratio of the light emitted from the backlight unit, so that an image is displayed. The backlight unit generates and provides light to the liquid crystal panel.

The panel driving part includes a gate driving part driving a gate line, a data driving part driving a data line, a power supply part supplying power, and a timing controller controlling driving timing of the gate driving part and the data driving part.

The gate driving part and the data driving part are electrically connected to one side of the liquid crystal panel. The gate driving part and the data driving part provide the liquid crystal panel with driving signals generated from each of the gate driving part and the data driving part.

The receiving container unit includes a bottom receiving container and a top receiving container. The bottom receiving container receives and fixes the backlight unit. The top receiving container surrounds an upper outline of the liquid crystal panel and to prevent the liquid crystal panel from moving.

The top receiving container includes a frame comprising metal formed through a press process. In the press process, the manufacturing cost is increased as a size of a mold for manufacturing the top receiving container is increased. To reduce costs, the top receiving container can be manufactured through a molding process using a polymer material. In the molding process, each of drivers in the gate driving part and the data driving part generates heat when the gate driving part and the data driving part are driven at a high frequency. When the top receiving container includes a polymer material, the heat generated from the gate and data drivers may remain inside the top receiving container. The heat may cause a failure or damage to the drivers.

A driving failure of the liquid crystal panel can be generated by electro-magnetic interference (“EMI”) or electrostatic discharge (“ESD”) of the liquid crystal panel. The EMI and the ESD are generated by an electromagnetic wave generated from the gate and data drivers.

### SUMMARY OF THE INVENTION

According to an exemplary embodiment of the present invention, a receiving container comprises a first frame disposed at a first side of a liquid crystal panel, and a second frame disposed at a second side of the liquid crystal panel, wherein the first frame and the second frame are combined to fix the liquid crystal panel and comprise different materials.

The first frame may comprise aluminum.

The second frame may comprise a polymer material.

The second frame may comprise metal.

The receiving container may further comprise a combining part for combining the first frame and the second frame.

The combining part may comprise a combining protrusion formed at one of the first and second frames and a combining hole formed at the remaining one of the first and second frames, and the combining protrusion and the combining hole are mated with each other.

The combining part may comprise a guiding protrusion formed at one of the first and second frames and a guiding hole formed at the remaining one of the first and second frames, and the guiding protrusion and the guiding hole are coupled with each other as a sliding structure.

According to an exemplary embodiment of the present invention, a liquid crystal display apparatus comprises a liquid crystal panel, and a top receiving container including a first frame disposed at a first side of the liquid crystal panel and a second frame disposed at a second side of the liquid crystal panel, wherein the first frame and the second frame are combined to fix the liquid crystal panel and comprise different materials.

The liquid crystal display apparatus may further comprise a gate driving part and a data driving part driving the liquid crystal panel, wherein the first frame contacts at least one driving part of the gate and data driving parts, and the first frame comprises metal.

The first frame may comprise aluminum or an aluminum alloy.

The first frame may comprise a groove part contacting at least one driving part of the gate and data driving parts.

The first frame electrically may connect at least one driving part of the gate and data driving parts to a ground potential.

The liquid crystal display apparatus may further comprise a combining part combining the first frame and the second frame.

The combining part may comprise a combining protrusion formed at one of the first and second frames and a combining hole formed at the remaining one of the first and second frames, and the combining protrusion and the combining hole are mated with each other.

The combining part may comprise a guiding protrusion formed at one frame of the first and second frames a guiding hole formed at the remaining frame of the first and second frames, and the guiding protrusion and the guiding hole are coupled with each other as a sliding structure.

The second frame may comprise a polymer material.

The second frame may comprise metal.

The first frame may be divided into a third frame for heat dissipation of the data driving part and a fourth frame for heat dissipation of the gate driving part.

According to an exemplary embodiment of the present invention, a method for assembling a liquid crystal display apparatus comprises receiving a backlight unit in a mold frame, fixing a liquid crystal panel at the mold frame, combining a first frame and a second frame through a combining part, fixing the first frame to the mold frame, and fixing the second frame to the mold frame, wherein the first frame is disposed at a first side where one of the gate and data driving parts is formed, and the second frame is disposed at a second side of the liquid crystal panel.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view of an LCD apparatus in accordance with an exemplary embodiment of the present invention;

FIG. 2 is a cross-sectional view taken along the line I-I′ in FIG. 1 according to an exemplary embodiment of the present invention;

FIGS. 3 and 4 are perspective views illustrating various shapes of a top receiving container of an LCD apparatus in accordance with an exemplary embodiment of the present invention;

FIGS. 5 to 7 are perspective views illustrating a combining method of a top receiving container of an LCD apparatus in accordance with an exemplary embodiment of the present invention;

FIG. 8 is a flow chart illustrating a method for assembling an LCD apparatus in accordance with an exemplary embodiment of the present invention;

FIGS. 9 and 10 are perspective views illustrating a method for assembling an LCD apparatus in accordance with an exemplary embodiment of the present invention;

FIG. 11 is an exploded perspective view of an LCD apparatus in accordance with an exemplary embodiment of the present invention;

FIG. 12 is a perspective view illustrating a top receiving container of an LCD apparatus according to an exemplary embodiment of the present invention; and

FIG. 13 is an exploded perspective view illustrating a first frame according to an exemplary embodiment of the present invention.

### DESCRIPTION OF EXEMPLARY EMBODIMENTS

The present invention is described more fully hereinafter with reference to the accompanying drawings, in which exemplary embodiments of the invention are shown. The present invention may, however, be embodied in many different forms and should not be construed as limited to the embodiments set forth herein.

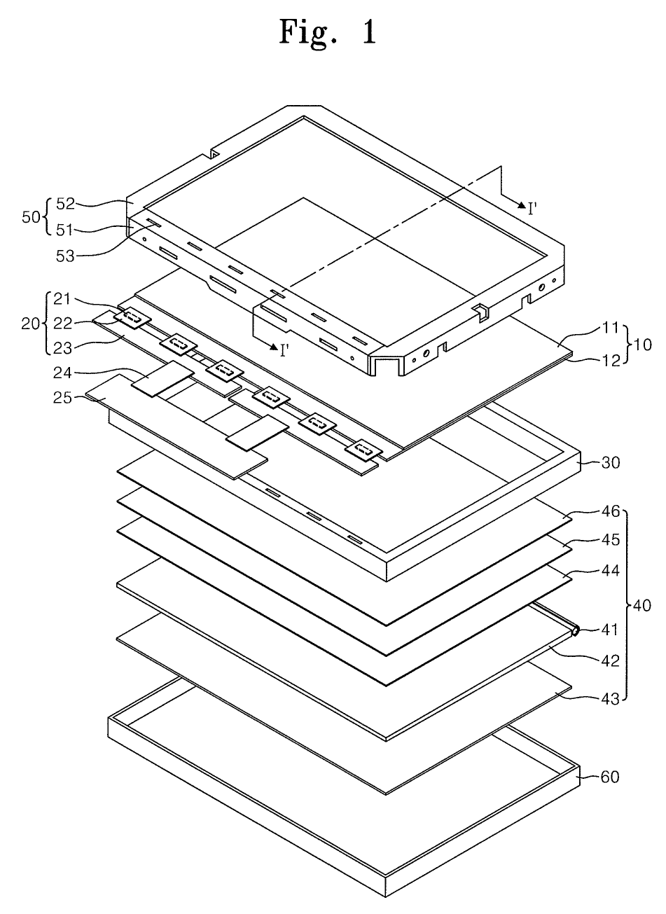

FIG. 1 is an exploded perspective view of a liquid crystal display (“LCD”) apparatus in accordance with an exemplary embodiment of the present invention.

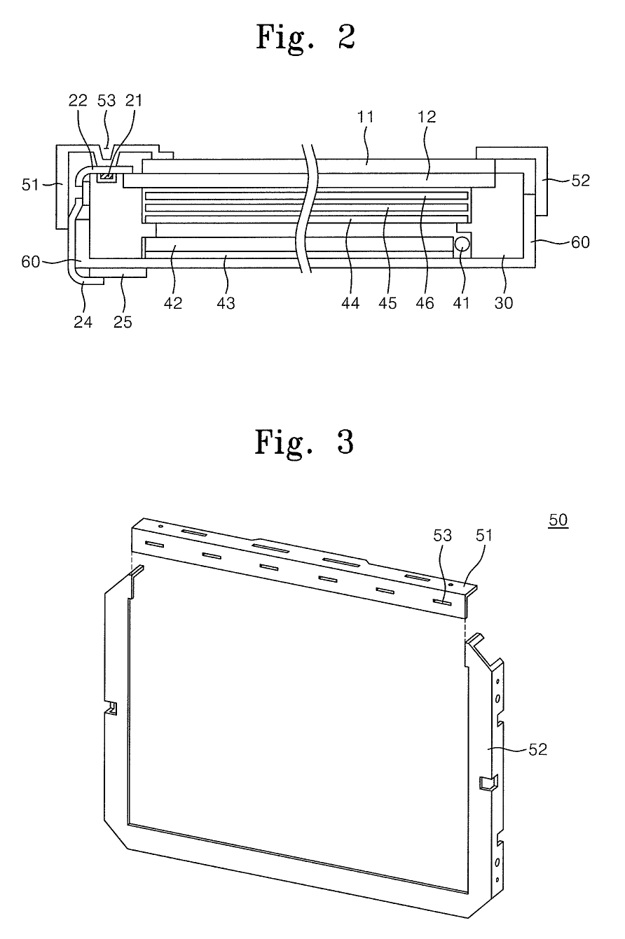

FIG. 2 is a cross-sectional view taken along the line I-I′ in FIG. 1 according to an exemplary embodiment of the present invention.

Referring to FIGS. 1 and 2, an LCD apparatus includes a liquid crystal panel 10, a panel driving part, a backlight unit 40 and a receiving container unit.

The liquid crystal panel 10 includes a thin film transistor (“TFT”) substrate 12 having a TFT array, a color filter substrate 11 having a color filter array, and a liquid crystal layer disposed between the two substrates 11 and 12.

The liquid crystal panel 10 includes a liquid crystal cell driven by a TFT formed at each pixel area. The liquid crystal panel 10 provides a pixel voltage received from the data line to a liquid crystal cell in response to a scan signal received from the gate line, and displays an image by driving the liquid crystal cell.

The panel driving part includes a gate driving part, a data driving part 20, a power supplying part, and a timing controller.

In an exemplary embodiment, the gate driving part is integrated in the liquid crystal panel 10. The gate driving part may be mounted as an integrated circuit in the liquid crystal panel 10. Alternatively, the gate driving part may be integrated in the liquid crystal panel 10. The gate driving part provides a gate driving signal to the gate line formed in the liquid crystal 10. In an exemplary embodiment, the gate driving part may sequentially provide a gate on voltage and a gate off voltage to the liquid crystal panel 10.

The data driving part 20 is electrically connected to one side of the liquid crystal panel 10, and provides the pixel voltage to the data line of the liquid crystal 10. The data driving part 20 includes a data tape carrier package (“TCP”) 22 and a data printed circuit board (“PCB”) 23. The data TCP 22 integrates a data driver 21 on a film. The data PCB 23 is electrically connected to the data TCP 22.

A side of the data TCP 22 is electrically connected to the TFT substrate 12 included in the liquid crystal panel 10. The other side of the data TCP 22 is electrically connected to the data PCB 23.

The timing controller provides a timing signal to the gate driving part and the data driving part 20, and provides a pixel data signal to the data driving part 20.

The power supplying part provides a gate on voltage and a gate off voltage to the gate driving part, and provides an analog driving voltage to the data driving part 20, and provides a common voltage to the liquid crystal panel 10, respectively.

The timing controller and the power supplying part can be mounted on a control PCB 25. An LCD apparatus used in, for example, a wide television may include two data PCBs 23 and an additional control PCB 25 as illustrated in FIG. 1. The control PCB 25 may be electrically connected to the timing controller and the power supplying part through each of the data PCB 23 and a connector 24. The control PCB 25 may transfer signals, generated in the timing controller and the power supplying part, to the data PCB 23.

The backlight unit 40 provides light to the liquid crystal panel 10. The backlight unit 40 may be an edge type backlight unit or a direct lighting type backlight unit. The edge type backlight unit may supply light through a side of the liquid crystal panel 10. The direct lighting type backlight unit may supply light through the bottom surface of the liquid crystal panel 10. In an exemplary embodiment of the present invention, the edge type backlight unit is used.

The backlight unit 40 includes at least one lamp 41, a light guide plate 42, a reflection sheet 43, a diffusive sheet 44, a prism sheet 45 and a protection sheet 46. The lamp 41 generates light and supplies the light to a side surface light entering part of the light guide plate 42. The light guide plate 42 guides the light from the lamp 41 to the liquid crystal panel 10. The reflection sheet 43 reflects the light provided downwardly toward the liquid crystal panel 10.

The diffusive sheet 44 diffuses the light provided from the light guide plate 42 to protect a bright line and a dark line. The prism sheet 45 increases straight characteristic of the diffusive light at the diffusive sheet 44, so that high brightness is provided to the liquid crystal panel 10. The protection sheet 46 protects against defects such as scratches when the backlight unit 40 is transported. In an exemplary embodiment, a light emitting diode (LED) may be used as a light source.

The backlight unit 40 is received and fixed by the mold frame 30 and the bottom receiving container 60.

A receiving part is formed to receive and fix the liquid crystal panel 10 in the mold frame 30, and a groove for preventing the data driver 21 from moving may be formed at a side of the mold frame 30. The liquid crystal panel 10 is received in the receiving part formed in the mold frame 30 after the backlight unit 40 is received in the mold frame 30. The liquid crystal panel 10 can be fixed with an adhesive member such as, for example, a double sided tape.

The receiving container unit includes the bottom receiving container 60 and the top receiving container 50. The bottom receiving container 60 receives and fixes the diffusive sheet 44, the prism sheet 45 and the protection sheet 46 fixed at the mold frame 30. The bottom receiving container 60 may include metal to prevent the backlight unit 40 from moving, and to protect the backlight unit 40 from an external physical shock.

The control PCB 25 can be adhered and fixed behind the bottom receiving container 60.

The top receiving container 50 has a reverse ‘L’ shape to receive a corner of an upper surface of the liquid crystal panel 10. The top receiving container 50 may include at least two different materials.

FIG. 3 is a perspective view illustrating a shape of a top receiving container of an LCD apparatus in accordance with an exemplary embodiment of the present invention.

The top receiving container 50 includes a first frame 51 and a second frame 52.

The first frame 51 includes a thermal conductive and electric conductive material such as, for example, metal. The first frame 51 overlaps the data driving part 20 to contact the data driving part 20. The first frame 51 overlaps the data driving part 20, so that heat generated by driving the data driving part 20 is transmitted to the first frame 51.

The first frame 51 includes an electric conductive material to be electrically connected to a ground potential of the data driving part 20, so that a distortion of driving signals by an electromagnetic wave can be prevented. The electromagnetic wave can be a high frequency caused by a driving frequency of the gate driving part 70 and the data driving part 20. For example, the first frame 51 may be electrically connected to a grounding line formed in the data TCP 22 of the data driving part 20. Thus, the first frame 51 may be worked as a ground potential and may enhance a ground potential of the data TCP 22.

The first frame 51 contacts an edge of the liquid crystal panel 10, and static electricity is electrically transmitted to the first frame 51, so that the liquid crystal panel 10 may be protected from the ESD. An area of the first frame 51, which contacts with the liquid crystal panel 10, may be extended toward the liquid crystal panel 10.

The first frame 51 may reduce a manufacturing cost when the first frame 51 is manufactured in a press process or an extrusion molding process because the first frame 51 has a small size in the above manufacturing process. According to an exemplary embodiment of the present invention, a mold size for manufacturing the first frame 51 is decreased. According to an exemplary embodiment of the present invention, manufacturing time can be decreased when the first frame 51 is manufactured in an injection molding process.

The first frame 51 may comprise, for example, metal having a good thermal and electric conductivity. The metal can be aluminum (Al) or an Al alloy. In an exemplary embodiment, the first frame 51 may include galvarium. The galvarium, which is an alloy of Al and Zn, has light-weight, good thermal and electric conductivity, and good strength.

The first frame 51 may include at least one groove part 53 for receiving the data driving part 20.

Referring to FIGS. 1 to 3, the groove part 53 formed at the top receiving container 50 extends toward the data driving part 20. The groove part 53 directly contacts the data TCP 22 and is physically connected to the data driver 21 of the data TCP 22. Since the groove part 53 physically contacts the data driver 21, heat generated by the data driver 21 is transmitted to the top receiving container 50.

The groove part 53 may be electrically connected to a ground line of the data TCP 22. Since the groove part 53 and the ground line of the data TCP 22 are electrically connected, failures such as the EMI or the ESD, generated by a high driving frequency of the data driver 21, may be prevented and a driving failure of the liquid crystal panel 10 may be prevented. A same number of the groove part 53 and the data TCP 22 may be formed.

The second frame 52 overlaps a peripheral area of the liquid crystal panel 10 where the data driving part 20 is not disposed. The second frame 52 fixes the overlapped peripheral area of the liquid crystal panel 10. The second frame 52 includes a polymer material. The second frame 52 may be manufactured by a molding method.

The second frame 52 may include a conductive material. For example, the second frame 52 may include a conductive plastic material, so that the EMI or the ESD may be prevented.

The second frame 52 may include metal, for example, a metal which is cheaper than aluminum (Al) or an Al alloy. In an exemplary embodiment, the second frame 52 may be manufactured by the same method as the first frame 51.

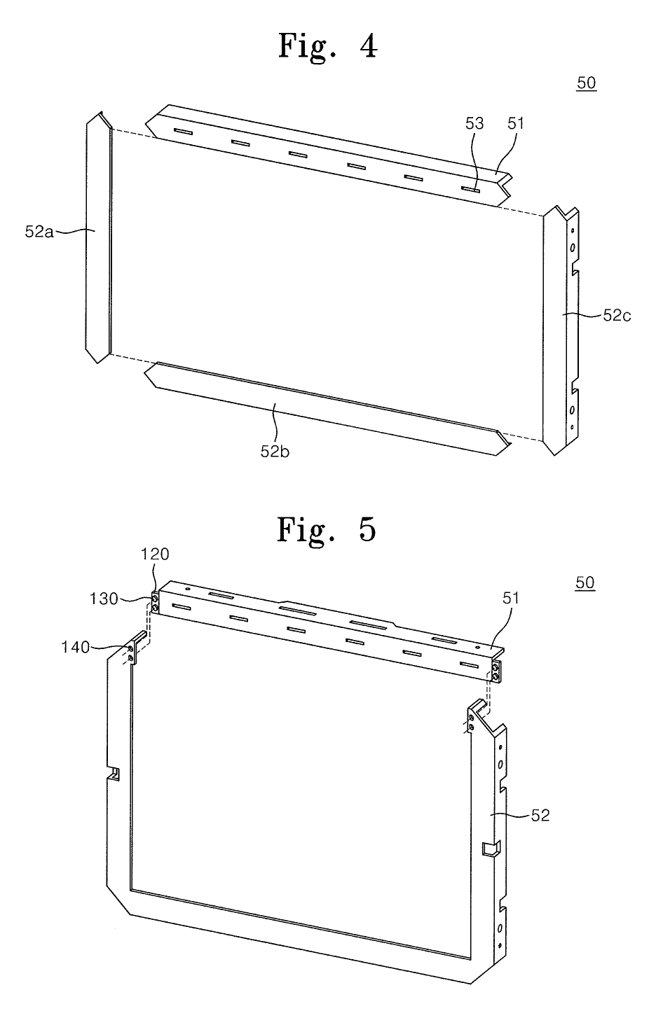

FIG. 4 is perspective view illustrating a top receiving container of an LCD apparatus in accordance with an exemplary embodiment of the present invention. In an exemplary embodiment, the top receiving container 50 may include four frames.

Referring to FIG. 4, the second frame 52 may include three frames 52a, 52b and 52c, and the three frames may be fixed at sides of the liquid crystal panel using a variety of methods. Alternatively, each of the frames 52a, 52b and 52c may be assembled prior to being fixed to three sides of the liquid crystal panel.

In an exemplary embodiment, the first frame 51 and the second frame 52 may be coupled to each other using, for example, a screw. In an exemplary embodiment, the first and second frames 51 and 52 may be assembled separately and respectively before being combined.

FIG. 5 is a perspective view illustrating a combining method of a first frame and a second frame of a top receiving container according to an exemplary embodiment of the present invention.

In an exemplary embodiment, first frame 51 and the second frame 52 are combined by inserting a combining protrusion 130 into a combining hole 140. The combining protrusion 130 is formed at the first frame 51, and the combining hole 140 is formed at the second frame 52.

The first frame 51 includes an extension part 120 and the combining protrusion 130. The extension part 120 is protruded from both ends of the first frame 51. The combining protrusion 130 is protruded from the extension part 120.

The extension part 120 and the first frame 51 may be formed using substantially the same process. The process includes, for example, a press process or a mold injection process.

The combining protrusion 130 and the first frame 51 may be formed using substantially the same process. The process includes, for example, a press process or a mold injection process. At least one combining protrusion 130 is protruded from an upper surface of the extension part 120. An end portion of the combining protrusion 130 may have a circular shape or a polygon shape. The end portion of the combining protrusion 130 may have a wedge shape. A center portion of the combining protrusion 130 may be divided into, for example, two or four pieces.

The combining hole 140 is formed at the second frame 52. The combining hole 140 corresponds to the combining protrusion 130. The combining hole 140 is formed in substantially the same shape as the combining protrusion 130, so that the combining protrusion 130 may be inserted into the combining hole 140.

The combining protrusion 130 and the combining hole 140 are mated to combine the first frame 51 and the second frame 52.

Alternatively, the combination protrusion 130 may be formed at the second frame 52, and the combination hole 140 may be formed at the first frame 51.

In an exemplary embodiment, the combining hole 140 may have a size corresponding to a combining hole of the second frame 52. The holes of the first frame 51 and the second frame 52 may be mated with a screw.

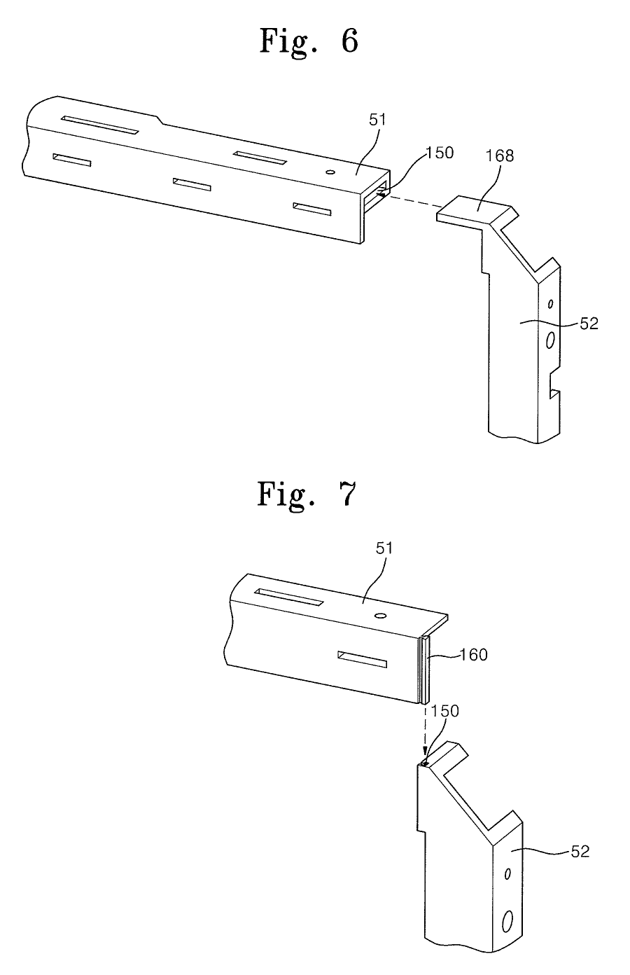

FIGS. 6 and 7 are perspective views illustrating a method of combining a first frame and a second frame according to an exemplary embodiment of the present invention.

Referring to FIG. 6, a guide groove 150 formed at the first frame 51 and a guide protrusion 160 formed at the second frame 52 are mated to combine the first frame 51 and the second frame 52.

The guide groove 150 is formed at both end portions of the first frame 51. The guide protrusion 160 corresponding to the guide groove 150 is formed at both end portions of the second frame 52.

The guide groove 150 is formed at both end portions of the first frame 51. A side surface of the first frame 51 is bent toward an inside as a ‘U’ shape to form the guide groove 150. The guide groove 150 is formed at an area which does not overlap the liquid crystal panel 10. The area where the guide groove 150 is formed receives the mold frame 30 or the bottom receiving container 60 such that a thickness of the LCD apparatus can be reduced.

The guide protrusion 160 is protruded from both end portions of the second frame 52. The guide protrusion 160 may be inserted into the guide groove 150 formed at the first frame 51. The guide groove 150 and the guide protrusion 160 may be mated by a torx method to combine the first frame 51 and the second frame 52.

A cross-sectional shape of the guide groove 150 and the guide protrusion 160 may be formed as a circular shape, an oval shape, a polygon shape or a rectangular shape. A plurality of guide grooves and guide protrusions may be formed at the first frame and the second frame, respectively. The guide protrusion 160 in FIG. 6 may be formed at the first frame 51, and the guide groove 150 may be formed at the second frame 52.

The guide groove 150 and the guide protrusion 160 may be mated in a vertical direction with respect to each other. Referring to FIG. 7, the guide protrusion 160 is formed at the first frame 51, and the guide groove 150 is formed at the second frame 52.

The guide protrusion 160 can be formed at an end portion of the first frame 51. The guide protrusion 160 can be formed at a first end portion of the first frame 51, and the substantially same guide protrusion 160 may be formed at a second end portion of the first frame 51. The guide protrusion 160 is extruded toward the end portions of the first frame 51 to be mated with the guide groove 150 in a vertical direction. A groove is formed in a perpendicular direction with respect to the guide protrusion 160. The groove formed in the perpendicular direction may be formed as a protruded shape.

The guide groove 150 is formed near the end portion of the second frame 52 in a perpendicular direction. The guide protrusion 160 may be inserted into the guide groove 150. The guide protrusion 160 is inserted into the guide groove 150 using a sliding structure.

Alternatively, the guide groove 150 may be formed at the first frame 51, and the guide protrusion 160 may be formed at the second frame 52.

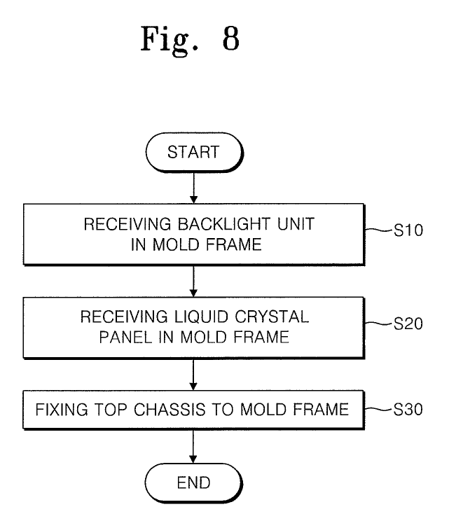

FIG. 8 is a flow chart illustrating a method for assembling an LCD apparatus in accordance with an exemplary embodiment of the present invention.

A backlight unit is received in a mold frame at step S10, and a liquid crystal panel is received in the mold frame at step S20, and a top receiving container is fixed to the mold frame at step S30.

Referring to FIGS. 1 and 8, in step S10, the diffusive sheet 44, the prism sheet 45 and the protection sheet 46 are received in an upper portion of the mold frame 30. The lamp 41, the light guide plate 42 and the reflection sheet 43 are received behind the mold frame 30.

In step S20, the liquid crystal panel 10 is received in an upper portion of the mold frame 30. The liquid crystal panel 10 may be received in an area of the mold frame 30 where the protection sheet 46 is received. The liquid crystal panel 10 is fixed to the mold frame 30 with an adhesive member such as, for example, a double sided tape. A receiving part, formed as a stepped shape to receive the liquid crystal panel 10, is formed at the mold frame 30. An adhesive member such as, for example, a bonding agent is formed at the receiving part of the mold frame 30, thereby the liquid crystal panel 10 is fixed.

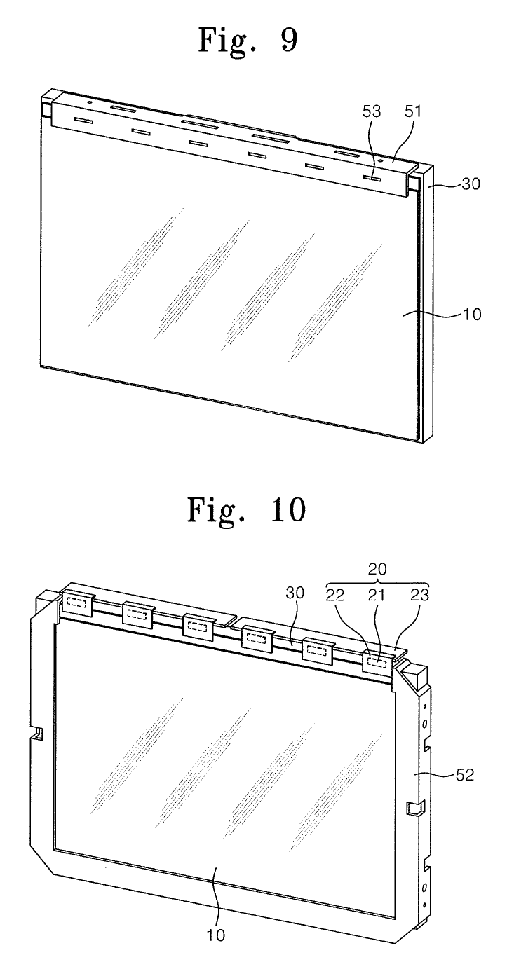

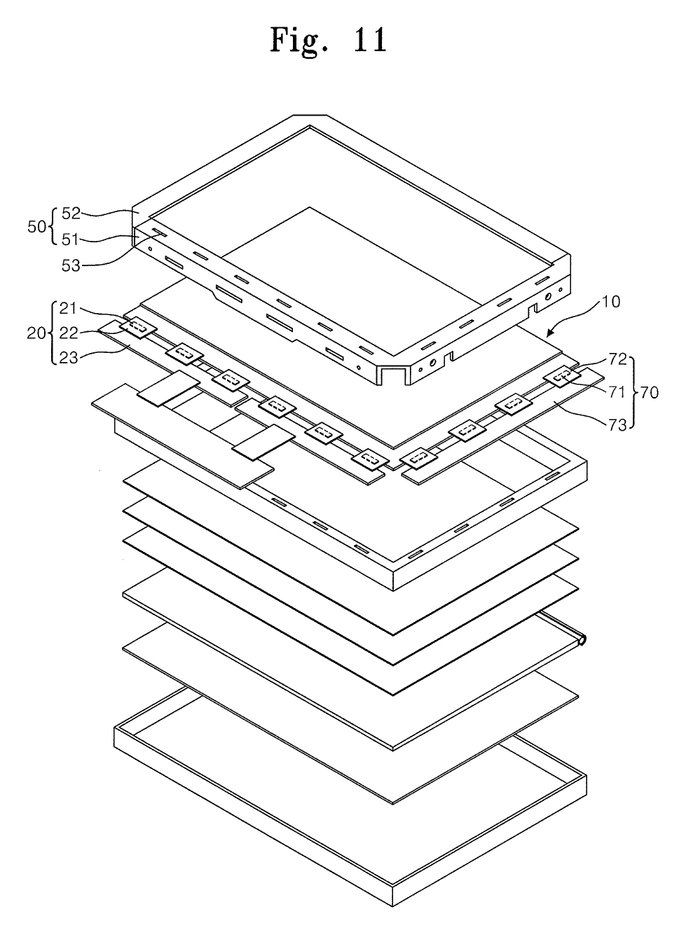

Referring to FIGS. 8-10, in step S30, the first frame 51 is fixed at one side of the mold frame 30 where the data TCP 22 of the liquid crystal panel 10 is adhered. Then, the second frame 52 is fixed at the mold frame 30.

After the second frame 52 is fixed at the mold frame 30, the first frame 51 is fixed at the mold frame 30. The mold frame 30 and the top receiving container 50 may be fixed through, for example, a bolt or a hook.

Referring to FIG. 5, the first and second frames 51 and 52 may be combined by a torx method through the combining protrusion 130 and the combining hole 140, and may be fixed at the mold frame 30. Referring to FIGS. 6 and 7, the first and second frames 51 and 52 may be combined by the guide groove 150 and the guide protrusion 160 through a sliding method, and may be fixed at the mold frame 30.

When the second frame 52 includes three frames, each of the frames of the second frame 52 may be fixed at the mold frame 30 in sequence. Each of the frames of the second frame 52 may be combined first and then be fixed at the mold frame 30.

FIG. 11 is an exploded perspective view illustrating an LCD apparatus in accordance with an exemplary embodiment of the present invention. Referring to FIG. 11, a gate driving part 70 is attached to a liquid crystal panel 10. A first frame 51 is formed at one side of a top receiving container 50 where the gate driving part 70 and a data driving part 20 are formed. A second frame 52 is formed at the remaining sides of the top receiving container 50 where the gate driving part 70 and the data driving part 20 are not formed.

The LCD apparatus in accordance with an exemplary embodiment of the present invention includes the top receiving container 50 having the first frame 51 and the second frame 52. The first frame 51 is disposed at the side of the liquid crystal panel 10 where the gate driving part 70 and the data driving part 20 are attached, and the second frame 52 is disposed at the remaining sides of the liquid crystal panel 10.

The gate driving part 70 is attached to one side of the liquid crystal panel 10. The gate driving part 70 includes a gate driver 71, a gate TCP 72 on which the gate driver 71 is mounted, and a gate PCB 73 electrically connected to the gate TCP 72.

The gate driver 71 is mounted on the gate TCP 72. The gate driver 71 is mounted on a film of the gate TCP 72, and one end portion of the gate TCP 72 is electrically connected to the liquid crystal panel 10 and the other end portion of the gate TCP 72 is electrically connected to the gate PCB 73.

The gate PCB 73 provides gate on/off voltages and control signals to the gate TCP 72. The gate on/off voltages and the control signals are inputted from the power supplying part via the data driving part 20. The gate PCB 73 may be omitted. For example, when a signal line electrically connected to the gate driver 71 is formed at the liquid crystal panel 10, a gate driving signal may be provided through the signal line to the gate driver 71, thereby the gate PCB 73 may be omitted.

The top receiving container 50 includes the first frame 51 and the second frame 52. The first frame 51 is formed in an area of the liquid crystal panel 10 connected to the gate TCP 72 and the data TCP 22, and the second frame 53 is formed in the remaining area of the liquid crystal panel 10.

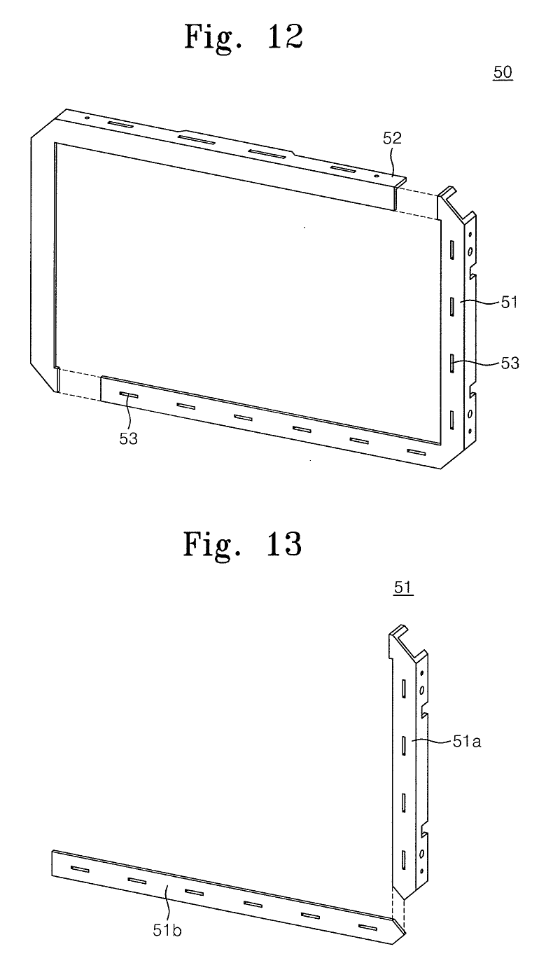

FIG. 12 is a perspective view illustrating a top receiving container of an LCD apparatus according to an exemplary embodiment of the present invention.

The first frame 51 receives an area where the gate driving part 70 and the data driving part 20 are connected to the liquid crystal panel 10. The first frame 51 is physically connected to the gate driving part 70 and the data driving part 20. The first frame is formed as an ‘L’ shape, and one side of the first frame 51 contacts the gate TCP 72, and the remaining side of the first frame contacts the data TCP 22.

The first frame 51 transmits heat generated in the gate TCP 72 and the data TCP 22. Since the first frame 51 is electrically connected to a grounding line formed at each of the gate TCP 72 and the data TCP 22, the EMI caused by a high speed operation of the gate driver 71 and the data driver 21 may be prevented.

The first frame 51 may further include a groove part 53 for electrically connecting with the gate TCP 72. The groove part 53 and the data TCP 22 can be formed with substantially the same method.

Referring to FIG. 13, the first frame 51 may be divided into a third frame 51a connected to the gate driving part 70 and a fourth frame 51b connected to the data driving part 20.

The first frame 51 may be formed by, for example, a press process or an injection molding process. The first frame 51 may include aluminum (Al) or an Al alloy. In an exemplary embodiment, the first frame 51 may include Al—Zn alloy.

The second frame 52 is formed except for an area where the first frame 51 is fixed at the liquid crystal panel 10. The second frame 52 includes one of a polymer material or metal. The second frame 52 may include a conductive material when the second frame 52 includes the polymer material.

An LCD apparatus and a method for manufacturing the LCD apparatus in accordance with exemplary embodiments of the present invention use a top receiving container having two different materials.

A first frame of the top receiving container may include a thermally conductive material. As such, heat generated at drivers for driving a liquid crystal panel may be transmitted effectively to an outside.

A conductive rubber formed at an end portion of the top receiving container can be omitted.

Since conductive areas of the panel driving part and the top receiving container are electrically connected to each other, a driving failure such as the EMI or the ESD generated at the panel driving part may be prevented.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A receiving container comprising:
a first frame disposed at a first side of a liquid crystal panel; and
a second frame disposed at a second side of the liquid crystal panel,
wherein the first frame and the second frame are combined to fix the liquid crystal panel and comprise different materials.

2. The receiving container of claim 1, wherein the first frame comprises aluminum.

3. The receiving container of claim 1, wherein the second frame comprises a polymer material.

4. The receiving container of claim 1, wherein the second frame comprises metal.

5. The receiving container of claim 1, further comprising a combining part for combining the first frame and the second frame.

6. The receiving container of claim 5, wherein the combining part comprises a combining protrusion formed at one of the first and second frames and a combining hole formed at the remaining one of the first and second frames, and the combining protrusion and the combining hole are mated with each other.

7. The receiving container of claim 5, wherein the combining part comprises a guiding protrusion formed at one of the first and second frames and a guiding hole formed at the remaining one of the first and second frames, and the guiding protrusion and the guiding hole are coupled with each other as a sliding structure.

8. A liquid crystal display apparatus comprising:
a liquid crystal panel; and
a top receiving container including a first frame disposed at a first side of the liquid crystal panel and a second frame disposed at a second side of the liquid crystal panel, wherein the first frame and the second frame are combined to fix the liquid crystal panel and comprise different materials.

9. The liquid crystal display apparatus of claim 8, further comprising a gate driving part and a data driving part driving the liquid crystal panel, wherein the first frame contacts at least one driving part of the gate and data driving parts, and the first frame comprises metal.

10. The liquid crystal display apparatus of claim 9, wherein the first frame comprises aluminum or an aluminum alloy.

11. The liquid crystal display apparatus of claim 10, wherein the first frame comprises a groove part contacting at least one driving part of the gate and data driving parts.

12. The liquid crystal display apparatus of claim 11, wherein the first frame electrically connects at least one driving part of the gate and data driving parts to a ground potential.

13. The liquid crystal display apparatus of claim 12, further comprising a combining part combining the first frame and the second frame.

14. The liquid crystal display apparatus of claim 13, wherein the combining part comprises a combining protrusion formed at one of the first and second frames and a combining hole formed at the remaining one of the first and second frames, and the combining protrusion and the combining hole are mated with each other.

15. The liquid crystal display apparatus of claim 13, wherein the combining part comprises a guiding protrusion formed at one frame of the first and second frames a guiding hole formed at the remaining frame of the first and second frames, and the guiding protrusion and the guiding hole are coupled with each other as a sliding structure.

16. The liquid crystal display apparatus of claim 12, wherein the second frame comprises a polymer material.

17. The liquid crystal display apparatus of claim 12, wherein the second frame comprises metal.

18. The liquid crystal display apparatus of claim 12, wherein the first frame is divided into a third frame for heat dissipation of the data driving part and a fourth frame for heat dissipation of the gate driving part.

19. A method for assembling a liquid crystal display apparatus comprising:
receiving a backlight unit in a mold frame;
fixing a liquid crystal panel at the mold frame;
combining a first frame and a second frame through a combining part fixing the first frame to the mold frame; and
fixing the second frame to the mold frame,
wherein the first frame is disposed at a first side where one of the gate and data driving parts is formed, and the second frame is disposed at a second side of the liquid crystal panel.
